(19) United States
(12) Patent Application Publication
(10) Pub. No.: US 2009/0134800 A1
(43) Pub. Date: May 28, 2009

(54) Electrode System for a Lamp

(75) Inventors: Rainer Koger, Berlin (DE); Dirk Rosenthal, Gaimersheim (DE); Klaus-Dieter Stein, Munchen (DE)

Correspondence Address: OSRAM SYLVANIA INC, 100 ENDICOTT STREET, DANVERS, MA, 01923, US

(73) Assignee: Patent-Treuhand-Gesellschaft Fur Ekektrische Gruhlampen MBH, Munchen (DE)

(21) Appl. No.: 11/922,770

(22) PCT Filed: Jun. 22, 2006
(86) PCT No.: PCT/DE2006/001065

§ 371 Date: Dec. 30, 2008

(30) Foreign Application Priority Data
Jun. 28, 2005 (DE) 10 2005 030 113.4

(51) Int. Cl. H01J 61/073; B23K 31/02; H01J 1/02

(52) U.S. Cl. 313/631; 228/101; 313/326; 313/311

(57) ABSTRACT

An electrode system for lamp engineering has at least one electrode holding rod and an electrode head, which are connected to one another by a soldering filler in a soldering process, the soldering filler being a sintered shaped part consisting of an essentially eutectic alloy.

### TECHNICAL FIELD

The invention relates to an electrode system in accordance with the precharacterizing clause of patent claim 1, a method for producing such an electrode system in accordance with the precharacterizing clause of patent claim 10 and a discharge lamp provided with such an electrode system.

### PRIOR ART

The electrode system according to the invention can in principle be used in a large number of different lamps. However, the main application area of the electrode system should be in the production of high-wattage HBO® or XBO® high-pressure discharge lamps.

It is known from the general prior art to use high-temperature soldering fillers (solders) consisting of pure platinum wire for producing soldered joints on electrode systems for high-wattage HBO® or XBO® high-pressure discharge lamps. Such electrode systems essentially comprise an electrode head, which is fixed on an electrode holding rod via a soldered joint. In order to produce the soldered joint, the platinum wire is introduced as soldering filler into an accommodating hole in the electrode head. Then, the electrode holding rod is inserted into the accommodating hole. In a further working step, the electrode system is heated to the soldering temperature in the region of the solder point and the platinum wire which has been introduced is melted on. Owing to the resultant surface bonding and mutual diffusion between the soldering filler and the parent metal, the electrode head is electrically conductively soldered to the electrode holding rod with high strength. Such soldering fillers consisting of pure platinum wire do make a high-temperature soldered joint of the electrode system possible, but are very cost-intensive owing to the low amount of platinum deposits and, as a result, increase the production costs of the electrode system.

For this reason, soldering fillers consisting of a more cost-effective zirconium wire are already used in lamp production. One disadvantage with such soldering fillers is the fact that, in the soldering process, the joining point may be embrittled without sufficient diffusion of the soldering filler into the parent metals. In other words, the soldering filler zirconium does not diffuse sufficiently into the structure of the parent metals and does not form an alloy, or only forms a deficient alloy. In the case of such soldered joints this may result in a brittle fracture of the soldered joint and therefore failure of the electrode system.

In order to improve the joining properties, it is furthermore known from the general prior art to use paste-like or pulverulent soldering fillers consisting of high-temperature molybdenum/ruthenium alloys for soldering the electrode systems. Although these solutions allow for improved strength of the soldered joint in comparison with zirconium-containing soldering fillers at a reduced melting temperature in comparison with the individual solder constituents, they are not suitable for producing high-strength soldered joints owing to the organic substances contained in pastes and the undesirable residues which remain, as a result, in particular in closed soldering areas i.e. in soldering processes with introduced solder. Pulverulent soldering fillers, on the other hand, are difficult to handle and, owing to the health risk, for example posed by the inhalation of the very fine pulverulent particles, are only suitable for the manufacture of electrode systems when using suitable protective devices.

### DESCRIPTION OF THE INVENTION

The invention is based on the object of providing an electrode system for lamp engineering and a method for producing such an electrode system, in the case of which electrode system and method an improved soldered joint is made possible with minimum complexity in terms of apparatus in comparison with conventional solutions.

This object is achieved as regards the electrode system by the combination of features in claim 1 and as regards the method for producing such an electrode system by the features in claim 10. Particularly advantageous embodiments of the invention are described in the dependent claims.

The electrode system according to the invention for lamp engineering has an electrode holding rod and an electrode head, which are connected to one another by means of a soldering filler in a soldering process. According to the invention, the soldering filler is a sintered shaped part consisting of an essentially eutectic alloy. Owing to the formation of the soldering filler as a sintered shaped part with any desired geometry, this solution allows for improved handling in terms of manufacture. Owing to the use according to the invention of an essentially eutectic alloy, the shaped part has a fixed melting point, which is below the individual melting points of the alloy constituents and, as a result, substantially facilitates the production of the soldered joint. In other words, the shaped part according to the invention has a melting behavior without two-phase melting-on, which is typical for alloys, owing to the essentially eutectic composition of the powder mixture. The transition from the molten state to the solid state of the shaped part takes place completely and directly during cooling after the soldering process. After cooling, this solidification results in a fine-grained, uniform structure of the soldering material with excellent strength properties.

A method according to the invention for producing an electrode system takes place with the following steps:
a) introducing the sintered shaped part into the electrode head,
b) inserting the electrode holding rod into the electrode head, and
c) soldering the electrode holding rod to the electrode head.

In accordance with one particularly preferred exemplary embodiment of the invention, the shaped part is produced from a molybdenum/ruthenium powder mixture.

The molybdenum/ruthenium powder mixture preferably contains approximately 38 to 48% by weight of ruthenium. In this range, the alloy has essentially eutectic properties. As a result, an alloy is achieved which has a melting point which is suitable for the soldering process and the formation of a brittle, intermetallic sigma phase is prevented.

It has proven to be particularly advantageous if the molybdenum/ruthenium powder mixture contains 58% by weight of molybdenum and 42% by weight of ruthenium (MoRu42). This eutectic composition comprises a melting temperature which is lower than the individual alloy constituents molybdenum and ruthenium and, as a result, allows for simplified energy-efficient production of the electrode system. The melting temperature of the molybdenum/ruthenium alloy is in this case, for example, in the vicinity of the melting temperature of pure platinum.

In one exemplary embodiment according to the invention, the soldering filler in the form of a shaped part is matched, at least in sections, to the component contour of the joining partners, i.e. to the geometry of the electrode holding rods and/or the electrode head. The shaped part preferably has an essentially circular cross section. As a result, the shaped part can be handled in a simple manner in terms of manufacturing, for example for the purpose of soldering using solder introduced into the soldering area.

In accordance with one particularly preferred exemplary embodiment, the soldering filler is a soldering disk. Owing to their shape, the soldering disks can be produced in a simple manner in terms of manufacturing and the uniform injection of heat over the components is ensured, for example by means of induction or resistance soldering processes.

The shaped part is preferably introduced into a soldering area which is delimited, at least in sections, by the electrode holding rod and the electrode head in order to produce the soldered joint.

The electrode system according to the invention is preferably used for producing discharge lamps, in particular for producing high-wattage HBO® or XBO® high-pressure discharge lamps.

### BRIEF DESCRIPTION OF THE DRAWINGS

The invention will be explained in more detail below with reference to a preferred exemplary embodiment. In the drawings:

FIG. 1 shows a schematic illustration of an HBO® mercury vapor high-pressure discharge lamp having an electrode system according to the invention;

FIG. 2 shows a side view of the anode-side electrode system of the HBO® mercury high-pressure discharge lamp shown in FIG. 1 with the soldering filler inserted, and

FIG. 3 shows a detailed illustration of the soldering filler shown in FIG. 2.

### PREFERRED EMBODIMENT OF THE INVENTION

The invention will be explained below with reference to an HBO® mercury vapor high-pressure discharge lamp, which is used, for example, in microlithography for producing semiconductors. As has already been mentioned at the outset, the electrode system according to the invention is in no way restricted to such types of lamp, however.

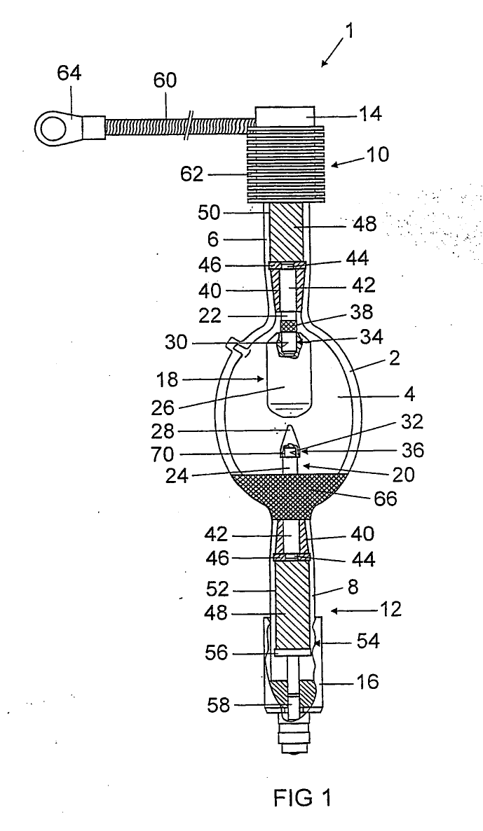

FIG. 1 shows a schematic illustration of an HBO® mercury vapor high-pressure discharge lamp 1 with a base at two ends using short-arc technology. This lamp has a discharge vessel 2 consisting of quartz glass and having an interior 4 and two diametrically arranged, sealed bulb shafts 6, 8, whose free end sections 10, 12 are each provided with a base sleeve 14, 16. Two diametrically arranged electrodes 18, 20 protrude into the interior 4, a gas discharge forming between these electrodes 18, 20 during lamp operation. Enclosed in the interior 4 of the discharge vessel 2 is an ionizable filling which essentially consists of mercury and a high-purity noble gas. The electrodes 18, 20 are each in the form of a two-part electrode system comprising a current-supplying rod-shaped electrode holder 22, 24 and a discharge-side head electrode 26 (anode) or head electrode 28 (cathode), which is soldered to said electrode holder 22, 24. In order to fit the electrode heads 26, 28 onto the electrode holding rods 22, 24, the electrode heads 26, 28 are each provided with a blind hole 30, 32 on the side remote from the discharge, end sections 34, 36 of the electrode holding rods 22, 24 being fixed in said blind holes 30, 32. As shown in FIG. 1, the lower electrode head 28 is in the form of a conical head cathode for the purpose of producing high temperatures in order to ensure a defined arc attachment and sufficient electron flow owing to thermal emission and field emission (Richardson equation). The upper electrode head 26 in FIG. 1 is in the form of a barrel-shaped head anode subjected to a high thermal load, in the case of which the emission power is improved by sufficient dimensioning of the electrode size. In order to suppress negative gas reactions for the luminous flux and the life performance of the discharge lamp 1, or at least to markedly reduce these negative gas reactions, a getter 38 consisting of tantalum is fixed within the discharge vessel 2. In the exemplary embodiment shown, the getter 38 is fitted to the anode-side electrode holding rod 22 in the form of a metal strip. In order to hold the electrodes 18, 20 in the discharge vessel 2, holding elements 40 which are in the form of truncated cones and consist of quartz glass are inserted into the bulb shafts 6, 8 and are provided with an axially extending through-hole 42 for the purpose of accommodating the electrode holding rods 22, 24. The holding rods 22, 24 of the electrodes 18, 20 are guided into the through-holes 42 such that they reach into the interior 4 and bear the electrode heads 26 and 28, respectively, there. On the base side, the electrode holding rods 22, 24 are each extended beyond the holding elements 40 and are inserted into an accommodating hole 44 in an annular molybdenum plate 46 and soldered to this molybdenum plate 46. The molybdenum plate 46 is adjoined in each case by a quartz cylinder 48, which is fused into the bulb shaft 6, 8, four molybdenum foils 52 being arranged on the outer surface 50 of said quartz cylinder 48, which molybdenum foils 52 are soldered to the molybdenum plate 46 and form a gas-tight current leadthrough. The molybdenum foils 52 are soldered to a contact plate 56 at an end section 54, said contact plate 56 being connected on the cathode side (at the bottom in FIG. 1) to a base pin 58 and on the anode side to a litz wire 60 for the purpose of making electrical contact with the electrode system 18, 20. The anode-side base sleeve 14 (at the top in FIG. 1) is also provided with cooling ribs 62 for the purpose of cooling it by means of convection. The electrical connection of the HBO® discharge lamp 1 to the supply voltage takes place on the cathode side via the base pin 58 and on the anode side via the litz wire 60 and a cable lug 64 connected thereto. The cathode-side region of the discharge vessel 2 is partially provided with a thermally reflective metallic coating 66 in order to improve the efficiency of the discharge lamp 1.

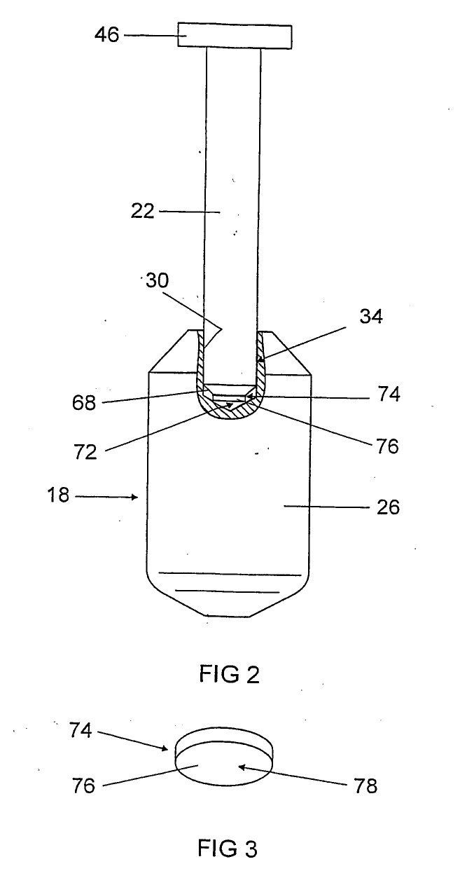

As shown in FIG. 2, which shows a side view of the anode-side electrode system 18 of the HBO® mercury high-pressure discharge lamp 1 shown in FIG. 1 prior to soldering the head anode 26 to the electrode holding rod 22, the end section 34 of the electrode holding rod 22 is provided with a circumferential bevel 68 and is inserted into the blind hole 30 in the head anode 26. Since the fixing of the head cathode 28 on the electrode holding rod 24 differs from the fixing of the head anode 26 only by a step-shaped bearing shoulder 70 of the discharge-side end section 36 (see FIG. 1), the general term “electrode head” will be used below for head anode 26 and head cathode 28. In order to produce the soldered joint, a soldering filler 74 is used which is introduced into the soldering area 72, which is delimited by the electrode holding rod 22 and the electrode head 26. According to the invention, the soldering filler 74 is a sintered shaped part 76 consisting of an essentially eutectic alloy. This solution allows for improved handling during manufacture owing to the formation of the soldering filler 74 as a sintered shaped part 76 with any desired geometry. Owing to the use according to the invention of an essentially eutectic powder mixture, the shaped part 76 has a fixed melting point, which is below the individual melting points of the alloy constituents in the vicinity of the melting point of pure platinum and, as a result, substantially facilitates the production of the soldered joint. The shaped part 76 therefore has a melting behavior without two-phase melting-on, which is typical for alloys, owing to the essentially eutectic composition. The transition from the molten state to the solid state takes place completely and directly during cooling of the soldered joint. This solidification results in a fine-grained, uniform structure for the melted-on shaped part 76 after cooling with excellent strength properties. In the exemplary embodiment shown, the sintered shaped part 76 contains a molybdenum/ruthenium powder mixture comprising 58% by weight of molybdenum and 42% by weight of ruthenium (MoRu42). This eutectic composition has a melting temperature which is lower than the individual alloy constituents molybdenum and ruthenium and, as a result, allows for simplified, energy-efficient production of the electrode system 18, 20. The melting temperature of the molybdenum/ruthenium alloy, which is cost-effective in comparison with pure platinum, is in this case in the region of the melting temperature of platinum. The shaped part 76 is produced in a pressing process at a pressure of approximately 8 kN and a subsequent sintering process at a temperature of approximately 1800° C.

As shown in FIG. 3, which shows a detailed illustration of the shaped part 76 shown in FIG. 2, the shaped part 76 is formed with a circular cross section, which is matched to the component contour of the joining partners, i.e. the electrode heads 26, 28 and electrode holding rods 22, 24. Owing to their disk-shaped shape, the shaped parts 76 can be produced using pressing technology in a simple manner in terms of manufacturing and ensure a uniform injection of heat during the soldering process. Furthermore, the sintered soldering disk 78 can be handled in a simple manner in terms of manufacturing in comparison with pulverulent soldering fillers. A health risk posed by the inhalation of very fine, pulverulent particles is prevented by the soldering filler 74 in the form of a solid.

Finally, the production of the electrode system 18, 20 will be explained by way of example below with reference to FIGS. 1 to 3. In a first working step, the shaped part 76 is introduced into the soldering area 72, i.e. into the blind holes 30, 32 in the electrode heads 26, 28. In a further working step, the electrode holding rod 22, 24 is inserted into the blind hole 30, 32, with the result that, as shown in FIG. 2, it bears against the shaped part 76 at one end. Then, the required soldering temperature is introduced into the soldering area 72 by means of injecting heat from the outside, for example by means of a high-frequency induction method. In this case, the soldering parameters are selected such that the heat input is sufficient to melt the shaped part 76 and, owing to the resultant surface bonding and mutual diffusion between the soldering filler 76 and electrode holding rod 22, 24 or electrode head 26, 28, to solder the workpieces electrically conductively to one another with high strength. After the input of heat, the shaped part 76 is completely melted and at least partially fills the soldering area 72, the end section 34, 36 of the electrode holding rod 22, 24 being accommodated completely in the blind hole 30, 32 in the electrode head 26, 28 (see FIG. 1). The solder gap between the end section 34, 36 of the electrode holding rod 22, 24 and the blind hole 30, 32 in the electrode head 26, 28 is in this case completely filled by the soldering filler 74 and produces a tight, electrically conductive connection.

The electrode system according to the invention is not restricted to the circular soldering disk 78 described, but the soldering filler 74 may have any desired geometric shape. In particular, the soldering filler 74 according to the invention may be produced as a wire-shaped or annular shaped part. Furthermore, the soldering filler 74 can be used for all soldering processes known from the prior art which allow for a defined introduction of heat into the soldering area 72. It is essential to the invention that the soldering filler 74 used for producing the soldered joint has an essentially eutectic alloy and is formed by a sintering process to give a shaped part 76.

The invention discloses an electrode system 18, 20 for lamp engineering, having at least one electrode holding rod 22, 24 and an electrode head 26, 28, which are connected to one another by means of a soldering filler 74 in a soldering process, the soldering filler 74 being a sintered shaped part 76 consisting of an essentially eutectic alloy.

1. An electrode system for lamp engineering, having at least one electrode holding rod (22, 24) and an electrode head (26, 28), which are connected to one another by means of a soldering filler (74) in a soldering process, characterized in that the soldering filler (74) is a sintered shaped part (76) consisting of an essentially eutectic alloy.

2. The electrode system as claimed in claim 1, the shaped part (76) being produced from a molybdenum/ruthenium powder mixture.

3. The electrode system as claimed in claim 2, the molybdenum/ruthenium powder mixture having approximately 38 to 48% by weight of ruthenium.

4. The electrode system as claimed in claim 2, the molybdenum/ruthenium powder mixture containing 58% by weight of molybdenum and 42% by weight of ruthenium (MoRu42).

5. The electrode system as claimed in claim 1, the shaped part (76) being matched, at least in sections, to the geometry of the electrode holding rod (22, 24) and/or the electrode head (26, 28).

6. The electrode system as claimed in claim 1, the shaped part (76) having an essentially circular cross section.

7. The electrode system as claimed in claim 1, the shaped part (76) being a soldering disk (78).

8. The electrode system as claimed in claim 1, the shaped part (76) being introduced into a soldering area (72) which is delimited, at least in sections, by the electrode holding rod (22, 24) and the electrode head (26, 28).

9. A discharge lamp, in particular an HBO® or XBO® high-pressure discharge lamp having an electrode system (18, 20) as claimed in claim 1.

10. A method for producing an electrode system (18, 20) as claimed in claim 1, having the following steps:
a) introducing the sintered shaped part (76) into the electrode head (26, 28),
b) inserting the electrode holding rod (22, 24) into the electrode head (26, 28), and
c) soldering the electrode holding rod (22, 24) to the electrode head (26, 28).

11. The electrode system as claimed in claim 3, the molybdenum/ruthenium powder mixture containing 58% by weight of molybdenum and 42% by weight of ruthenium (MoRu42).

12. The electrode system as claimed in claim 2, the shaped part (76) being matched, at least in sections, to the geometry of the electrode holding rod (22, 24) and/or the electrode head (26, 28).

13. The electrode system as claimed in claim 3, the shaped part (76) being matched, at least in sections, to the geometry of the electrode holding rod (22, 24) and/or the electrode head (26, 28).

14. The electrode system as claimed in claim 4, the shaped part (76) being matched, at least in sections, to the geometry of the electrode holding rod (22, 24) and/or the electrode head (26, 28).

15. The electrode system as claimed in claim 2, the shaped part (76) having an essentially circular cross section.

16. The electrode system as claimed in claim 3, the shaped part (76) having an essentially circular cross section.

17. The electrode system as claimed in claim 4, the shaped part (76) having an essentially circular cross section.

18. The electrode system as claimed in claim 5, the shaped part (76) having an essentially circular cross section.

19. The electrode system as claimed in claim 2, the shaped part (76) being a soldering disk (78).

20. The electrode system as claimed in claim 3, the shaped part (76) being a soldering disk (78).
